(19) United States
(12) Patent Application Publication
(10) Pub. No.: US 2025/0185654 A1
(43) Pub. Date: Jun. 12, 2025

(54) ALTERNATIVE CORROSION INHIBITORS

(71) Applicant: S. C. JOHNSON & SON, INC., Racine, WI (US)

(72) Inventors: Christina Rozeske, Sturtevant, WI (US); Steven J. Suess, Racine, WI (US)

(21) Appl. No.: 18/976,252

(22) Filed: Dec. 10, 2024

Related U.S. Application Data
(60) Provisional application No. 63/609,127, filed on Dec. 12, 2023.

(51) Int. Cl. A01N 43/08; A01N 25/04; A01N 41/02; A01N 65/22; A01P 17/00

(52) U.S. Cl. CPC A01N 43/08; A01N 25/04; A01N 41/02; A01N 65/22; A01P 17/00

(57) ABSTRACT

The present disclosure provides a composition that includes one or more active ingredients and a corrosion inhibitor. Further, the corrosion inhibitor is selected from the group consisting of Vitamin C, Vitamin E, or combinations thereof.

### CROSS REFERENCE TO RELATED APPLICATIONS

This application is related to, claims priority to, and incorporates herein by reference for all purposes U.S. Provisional Patent Application No. 63/609,127, filed Dec. 12, 2023.

### BACKGROUND

### 1. Technology Field

The present disclosure relates generally to aerosol formulations, and more particularly, to pest control compositions that include a corrosion inhibitor.

### 2. Description of the Background

Products that use natural ingredients, such as natural pesticides (e.g., essential oils), are appealing to many consumers. However, natural ingredients may be ineffective corrosion inhibitors, and therefore, many formulations including all natural ingredients are required to be packaged in aluminum containers, rather than steel or other materials that would otherwise corrode more easily. Therefore, there remains a need to find a natural ingredient, preferably an ingredient that meets the U.S. EPA FIFRA 25(b) exemption, that effectively acts as a corrosion inhibitor, such that natural formulations may be packaged in a variety of aerosol cannisters constructed from varying materials, including steel.

### BRIEF DESCRIPTION OF DRAWINGS

The present disclosure may be better understood with reference to the following figures. The patent or application file contains at least one drawing executed in color. Copies of this patent or patent application publication with color drawing(s) will be provided by the Office upon request and payment of the necessary fee.

FIG. 1A shows top and bottom photographic images of a valve assembly at a beginning or baseline timepoint;

FIG. 1B shows top and bottom photographic images of the valve assembly of FIG. 1A after being submerged in Example Composition 1 for two weeks;

FIG. 1C shows top and bottom photographic images of the valve assembly of FIG. 1A after being submerged in Example Composition 1 for four weeks;

FIG. 1D shows top and bottom photographic images of the valve assembly of FIG. 1A after being submerged in Example Composition 1 for eight weeks;

FIG. 2A shows top and bottom photographic images of a valve assembly at a beginning or baseline timepoint;

FIG. 2B shows top and bottom photographic images of the valve assembly of FIG. 2A after being submerged in Example Composition 2 for two weeks;

FIG. 2C shows top and bottom photographic images of the valve assembly of FIG. 2A after being submerged in Example Composition 2 for four weeks;

FIG. 2D shows top and bottom photographic images of the valve assembly of FIG. 2A after being submerged in Example Composition 2 for eight weeks;

FIG. 3A shows top and bottom photographic images of a valve assembly at a beginning or baseline timepoint;

FIG. 3B shows top and bottom photographic images of the valve assembly of FIG. 3A after being submerged in Example Composition 3 for two weeks;

FIG. 3C shows top and bottom photographic images of the valve assembly of FIG. 3A after being submerged in Example Composition 3 for four weeks;

FIG. 3D shows top and bottom photographic images of the valve assembly of FIG. 3A after being submerged in Example Composition 3 for eight weeks;

FIG. 4A shows top and bottom photographic images of a valve assembly at a beginning or baseline timepoint;

FIG. 4B shows top and bottom photographic images of the valve assembly of FIG. 4A after being submerged in Example Composition 4 for two weeks;

FIG. 4C shows top and bottom photographic images of the valve assembly of FIG. 4A after being submerged in Example Composition 4 for four weeks;

FIG. 4D shows top and bottom photographic images of the valve assembly of FIG. 4A after being submerged in Example Composition 4 for eight weeks;

FIG. 5 is a photographic image of Example Compositions 1-4 after two weeks;

FIG. 6 is a photographic image of Example Compositions 1-4 after four weeks;

FIG. 7 is a photographic image of Example Compositions 1-4 after eight weeks;

FIG. 8A shows top and bottom photographic images of a valve assembly at a beginning or baseline timepoint;

FIG. 8B shows top and bottom photographic images of the valve assembly of FIG. 8A after positioning the valve assembly in a headspace above Example Composition 5 for one week;

FIG. 8C shows top photographic images of the valve assembly of FIG. 8A after positioning the valve assembly in a headspace above Example Composition 5 for two weeks;

FIG. 8D shows top and side photographic images of the valve assembly of FIG. 8A after positioning the valve assembly in a headspace above Example Composition 5 for three weeks;

FIG. 9A shows top and bottom photographic images of a valve assembly at a beginning or baseline timepoint;

FIG. 9B shows top, bottom, and side photographic images of the valve assembly of FIG. 9A after positioning the valve assembly in a headspace above Example Composition 6 for one week;

FIG. 9C shows top and bottom photographic images of the valve assembly of FIG. 9A after positioning the valve assembly in a headspace above Example Composition 6 for two weeks;

FIG. 9D shows top and bottom photographic images of the valve assembly of FIG. 9A after positioning the valve assembly in a headspace above Example Composition 6 for three weeks;

FIG. 10A shows top and bottom photographic images of a valve assembly at a beginning or baseline timepoint;

FIG. 10B shows top and bottom photographic images of the valve assembly of FIG. 10A after positioning the valve assembly in a headspace above Example Composition 7 for one week;

FIG. 10C shows top and bottom photographic images of the valve assembly of FIG. 10A after positioning the valve assembly in a headspace above Example Composition 7 for two weeks;

FIG. 10D shows top, bottom, and side photographic images of the valve assembly of FIG. 10A after positioning the valve assembly in a headspace above Example Composition 7 for three weeks;

FIG. 11A shows top and bottom photographic images of a valve assembly at a beginning or baseline timepoint;

FIG. 11B shows top and bottom photographic images of the valve assembly of FIG. 10A after positioning the valve assembly in a headspace above Example Composition 8 for one week;

FIG. 11C shows top and bottom photographic images of the valve assembly of FIG. 10A after positioning the valve assembly in a headspace above Example Composition 8 for two weeks;

FIG. 11D shows top, bottom, and side photographic images of the valve assembly of FIG. 10A after positioning the valve assembly in a headspace above Example Composition 8 for three weeks;

FIG. 12A shows top and bottom photographic images of a valve assembly at a beginning or baseline timepoint;

FIG. 12B shows top and bottom photographic images of the valve assembly of FIG. 12A after positioning the valve assembly in a headspace above Example Composition 9 for one week;

FIG. 12C shows top and bottom photographic images of the valve assembly of FIG. 12A after positioning the valve assembly in a headspace above Example Composition 9 for two weeks;

FIG. 12D shows top, bottom, and side photographic images of the valve assembly of FIG. 12A after positioning the valve assembly in a headspace above Example Composition 9 for three weeks;

FIG. 13 is a photographic image of Example Compositions 5-9 at the beginning or baseline timepoint;

FIG. 14 is a photographic image of Example Compositions 5-9 after one week;

FIG. 15 is a photographic image of Example Compositions 5-9 after two weeks; and

FIG. 16 is a photographic image of Example Compositions 5-9 after three weeks.

### SUMMARY

According to a first aspect of the present disclosure, a composition is provided that includes one or more actives and a corrosion inhibitor. Here, the corrosion inhibitor is selected from the group consisting of Vitamin C, Vitamin E, and combinations thereof. In some embodiments, the corrosion inhibitor is Vitamin C, and the composition has a pH between about 5 and about 8. In some embodiments, the corrosion inhibitor is Vitamin E, and the composition has a pH between about 5 and about 8. In some embodiments, the corrosion inhibitor is Vitamin E, and the composition has a pH between about 9 and about 12.

Additionally, the one or more active ingredients may be selected from the group consisting of pyrethrins, rosemary oil, cornmint oil, peppermint oil, spearmint oil, rosemary oil, thyme oil, citronella oil, clove oil, cedarwood oil, sodium lauryl sulfate, and any combination thereof/and wherein the one or more active ingredients may be about 0.001 wt. % to about 10 wt. %, based on the total weight of the composition. In some embodiments, the one or more active ingredients may be selected from the group consisting of rosemary oil, sodium lauryl sulfate, and a combination thereof. In some embodiments, the one or more active ingredients may be present in an amount of about 0.001 wt. % to about 10 wt. %, based on the total weight of the composition.

In some embodiments, the composition further includes one or more emulsifiers. The one or more emulsifiers may be selected from the group consisting of glycerin, potassium oleate, polysorbate 80, sorbitan monooleate, and any combination thereof. In some embodiments, the one or more emulsifiers may be present in an amount of about 0.1 wt. % to about 35 wt. %, based on the total weight of the composition.

In some embodiments, the composition may include a pH modifier. The pH modifier may be selected from the group consisting of citric acid, anhydrous citric acid, trisodium citrate, monosodium phosphate monohydrate, disodium phosphate heptahydrate, and combinations thereof. In other embodiments, the pH modifier may be present from about 0.001 wt. % to about 0.1 wt. %, based on the total weight of the composition. In further embodiments, the corrosion inhibitor may be present from about 0.05 wt. % to about 0.5 wt. %, based on the total weight of the composition.

In some embodiments, the composition may include a propellant selected from the group consisting of nitrogen, compressed air, and carbon dioxide. In some embodiments, the composition may include a solvent selected from the group consisting of ethanol, isopropanol, and combinations thereof. In some embodiments, the solvent may be present from about 0.5 wt. % to about 20 wt. %, based on the total weight of the composition.

According to an aspect of the present disclosure, a composition is provided that includes an active ingredient and Vitamin C.

The composition may have a pH from about 5.5 to about 7.

In some embodiments the composition may include an emulsifier.

In some embodiments, the active ingredient may be selected from the group consisting of sodium lauryl sulfate, rosemary oil, and any combination thereof.

According to an aspect of the present disclosure, a composition may be provided that includes an active ingredient and Vitamin E.

In some embodiments the composition may have a pH from about 7 to about 12.

### DETAILED DESCRIPTION

The present disclosure relates to pest control compositions that include a corrosion inhibitor.

Based on consumer demand, there is a need for compositions, including pest control compositions, that have high efficacy as well as consumer satisfaction regarding comfort and aesthetics. There is also a need for creating formulations or compositions that may be used in a variety of cannisters or containers, including aluminum and steel cannisters or containers. For example, aerosol containers can beneficially include a metal body, such as steel. Steel provides the benefits of heft and strength, which resists deformation and denting.

The pest control compositions disclosed herein are water-based and utilize one or more ingredients that comply with the FIFRA 25(b) minimum risk pesticide regulation to deliver a desirable and efficacious pesticide product. Furthermore, these compositions can be utilized and/or stored in a variety of container types, such as a container that has steel components (i.e., steel valve assemblies or components), or a body made of steel. More particularly, the formulations of the present disclosure may include vitamin C, vitamin E, or combinations thereof. It was unexpectantly determined that when vitamin C or vitamin E are combined with the active ingredients and stored with steel components as disclosed herein, corrosion of the steel components is dramatically reduced. Therefore, the consumer has a new benefit available to them which is an effective pest control composition that utilizes natural ingredients (i.e., Vitamin C and E) as corrosion inhibitors, is biodegradable, resists discoloration and corrosion, and can be held within robust containers made of steel having a pleasing heft.

Throughout the disclosure, the term “about” or “approx.,” as used herein, refers to variation in the numerical quantity that may occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture. In one embodiment, the term “about” refers to a range of values +/−5% of a specified value.

The term “weight percent”, “wt. %”, “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “wt. %”, etc.

As used herein, “pest” and/or “pests” can mean any organism whose existence it can be desirable to control. Pests can include, for example, arthropods, bacteria, cestodes, fungi, insects, nematodes, parasites, plants, and the like. In addition, as used herein, “pesticidal” can mean, for example, antibacterial, antifungal, antiparasitic, herbicidal, insecticidal, and the like.

More so, for purposes of simplicity, the term “insect” is used in this application. However, it should be understood that the term “insect” refers, not only to insects, but may also to mites, spiders, and other arachnids, larvae, and like invertebrates. As used herein, the term “insect” refers to and includes but is not limited to insects or arachnids capable of acting as vectors for disease to humans, animals, birds, fish, plants or plant parts, or capable of irritating or causing economic damage thereto. Examples include but are not limited to nematodes, biting insects (such as mosquitoes, gnats, horse flies, ticks, tsetse flies, blowfly, screw fly, bed bugs, fleas, lice and sea lice), sap-sucking insects (such as aphids and thrips) and further include arachnids, ticks, termites, silverfish, ants, cockroaches, locust, fruit flies, wasps, hornets, yellow jackets, scorpions, chiggers and mites (such as dust mites).

Further, for purposes of this application, the term “pest control” shall refer to having a repellant effect, a pesticidal effect, or both. “Repellant effect” is an effect wherein more insects are repelled away from a host or area that has been treated with the composition than a control host or area that has not been treated with the composition. Similarly, the term “repelling” or “repel” refers to the ability of the compositions described herein to cause a pest or insect to deviate away from or avoid a surface, object, or insect breeding site treated with the composition. In some embodiments, as will be shown in the present disclosure, a repellant effect is an effect wherein at least about 75% of insects are repelled away from a host or area that has been treated with the composition. In some embodiments, however, a repellant effect is an effect wherein at least about 90% of insects are repelled away from a host or area that has been treated with the composition. In addition, “pesticidal effect” is an effect wherein treatment with a composition causes at least about 1% insect mortality. In this regard, an LC1 to LC100 (lethal concentration) or an LD1 to LD100 (lethal dose) of a composition will cause a pesticidal effect. In some embodiments, the pesticidal effect is an effect wherein treatment with a composition causes at least about 5% of the exposed insects to die. In some embodiments, the target pest is a non-insect, such as a parasite.

As used herein, the term “knocking down” or “knockdown” refers to the ability of the composition described herein to render an insect immobile for a predetermined period of time. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease, or irritate is severely curtailed during the period in which it is knocked down.

As used herein, the term “killing” or “kill” refers to the ability of at least one active ingredient in a composition to render an insect dead.

The pest control compositions according to an embodiment of the present disclosure is a composition comprising (i) one or more active ingredients, (ii) at least one emulsifier, and (iii) an antioxidant as corrosion inhibitor. The composition can also include one or more of the following: (iv) at least one preservative, (v) at least one pH modifier or buffer, and/or (vi) a carrier. The pest control compositions described herein present a novel combination of active ingredients, emulsifiers, and corrosion inhibitors, resulting in an improved pest control composition effective in direct spray and space spray applications.

### Active Ingredients

In various embodiments, the one or more active ingredients can include pyrethrins or pyrethroids, essential oils or combinations thereof. In certain embodiments, the one or more active ingredients can include rosemary oil, spearmint oil, peppermint oil, and/or cornmint oil.

The one or more active ingredients may also include one or more actives selected from the group consisting of essential plant oils (including synthetic analogues), eugenol, 2-phenylethyl propionate, amyl butyrate, geraniol, limonene (e.g., d-limonene), linalool, methyl salicylate, pinene (e.g., alpha-pinene, beta-pinene), piperonal, piperonyl alcohol, tetrahydrolinalool, thymol, vanillin, ethyl vanillin, iso-eugenol, ethyl cinnamate, pyrethrins, abamectin, azadirachtin, amitraz, rotenone, boric acid, Spinosad, biopesticides, synthetic pesticides, and mixtures thereof.

The one or more actives may also include one or more actives selected from the group consisting of eugenol, 2-phenylethyl propionate, menthol, menthone, thymol, carvone (e.g., L-carvone), camphor, methyl salicylate, p-cymene, linalool, linalyl acetate, eucalyptol, alphapinene, bornyl acetate, isobornyl acetate, gamma-terpinene, cinnamyl acetate, cinnamic alcohol, cinnamaldehyde, and combinations thereof. The compositions of the present disclosure may also include an essential plant oil, such as corn mint oil, peppermint oil, spearmint oil, rosemary oil, thyme oil, citronella oil, clove oil, and cedarwood oil.

### Pyrethrins/Pyrethrin Extract

Pyrethrin extract is a Chrysanthemum flower extract that can be used as an insecticide. Pyrethrum is the total crude extract form obtained from flowers of a Chysanthamum plant, for example Chrysanthemum cinerariifolium. Pyrethrins are the 6 molecules found in pyrethrin extract that possess insecticidal properties: pyrethrin I, pyrethrin II, jasmolin I, jasmolin II, cinerin I, and cinerin II.

### Rosemary Oil (CAS No. 8000-25-7)

The constituents of the essential oil from rosemary (Rosmarinus officinalis L.) may include 1,8-cineol, camphor, camphene, p-cymene, eucalyptol, limonene, linalool, α-pinene, β-pinene, γ-terpinene, and thymol.

In particular embodiments, the active ingredient is at least one insecticide or insect repellent selected from the group consisting of pyrethrins, pyrethrin extract, essential oils (e.g., mint oil, rosemary oil), and combinations thereof. In particular embodiments, the active ingredient is at least one insecticide or insect repellent selected from the group consisting of pyrethrins, pyrethrin extract, rosemary oil, essential oils, and combinations thereof. In an embodiment, rosemary oil is the active ingredient. In yet another particular embodiment, pyrethrins is the active component. In another particular embodiment, a combination of pyrethrins and rosemary oil is the active component.

In various embodiments, the total amount of active ingredients present in the compositions disclosed herein can be an amount or from about 0.001 wt. % to about 10 wt. %, or from about 0.01 wt. % to about 8 wt. %, 0.02 wt. % to about 6 wt. %, or from about 0.05 wt. % to about 5 wt. %, or from about 0.1 wt. % to about 4 wt. %, or from about 0.2 wt. % to about 3 wt. %, or from about 0.5 wt. % to about 2 wt. %, or from about 1 wt. % to about 1.5 wt. %, where all weight percentages are percent by weight of the total composition.

While specific wt. % values chosen for this embodiment are recited, it is to be understood that, within the scope of the disclosure, the wt. % values of the active component may vary to suit different applications, such as by 10-20%.

Other Active Components. The compositions of the present disclosure, and the active component thereof, may also include other active components than those listed above. For instance, the composition may include one or more active ingredients eligible for minimum risk pesticide products that are exempt from the Federal Insecticide, Fungicide, and Rodenticide Act (FIFRA) under the Minimum Risk Exemption regulations in 40 U.S. Code of Federal Regulations 152.25(f), other than those already listed.

Sodium Lauryl Sulfate. In certain embodiments, sodium lauryl sulfate can be present in the compositions as an active component. In some embodiments, sodium lauryl sulfate can be present in the compositions in an amount of from about 0.001 wt. % to about 50 wt. %, about 0.01 wt. % to about 40 wt. % or about 0.1 wt. % to about 20 wt. %. In some embodiments, sodium lauryl sulfate can be present in the compositions in an amount between 15 wt. % and 20 wt. %. In some embodiments, sodium lauryl sulfate can be present in the compositions in an amount between 17 wt. % and 18 wt. %

Corrosion inhibitor. According to embodiments of the present disclosure, the composition may also include a corrosion inhibitor, for example, to help maintain the stability of the composition in a container (e.g., a steel can) for extended periods of time. Corrosion inhibitors can be used that are currently listed as eligible for FIFRA 25(b) pesticide products. In particular embodiments, the corrosion inhibitors can include sodium benzoate, monosodium phosphate disodium phosphate, Vitamin C, Vitamin E, and combinations thereof. In some embodiments, the corrosion inhibitor can be used in pH neutral solutions. In other embodiments, the corrosion inhibitor can be used in alkaline conditions. According to specific aspects of the present disclosure, Vitamin C and Vitamin E may be used as corrosion inhibitors for the formulations.

In some embodiments, the composition can include the corrosion inhibitor in about 0.05 wt. % to about 0.5 wt. %, based on the total weight of the composition. In other embodiments, the composition can include the corrosion inhibitor in about 0.05 wt. % to about 0.15 wt. %, based on the total weight of the composition. In other embodiments, the composition can include the corrosion inhibitor in about 0.1 wt. %, based on the total weight of the composition. While specific values chosen for this embodiment are recited, it is to be understood that, within the scope of the disclosure, the concentration of corrosion inhibitor may vary to suit different applications. The concentration ranges of corrosion inhibitor will vary based on the additional components of the pest control composition, such as the active components and the carrier.

### Other Components

The compositions of the present disclosure may also include one or more of what may be considered as inert or relatively inert components. In certain embodiments, for example, the compositions of the present disclosure may include an emulsifier, a solvent, a pH adjuster, a pH buffer, a preservative, and/or a carrier, or any combination thereof.

Emulsifiers. According to even further embodiments of the present disclosure, the composition may also include one or more emulsifiers, for example, to assist incorporation of hydrophobic components and to allow the formulation to be formed as an oil-in-water microemulsion. In various embodiments, the one or more emulsifiers can include glycerin. In certain embodiments, the emulsifier can include sodium lauryl sulfate or sodium dodecyl sulfate, polysorbate 20, polysorbate 60, polysorbate 65, polysorbate 80, potassium oleate, sorbitan monooleate, sorbitan monostearate, magnesium stearate, lecithin, polyglycerol esters, alkylene glycol esters of fatty acids, sodium salts of fatty acids, potassium salts of fatty acids, sucrose fatty acid esters, or combinations thereof. In some embodiments, the emulsifier can include non-ionic surfactants. In other embodiments, the emulsifier can include anionic surfactants, cationic surfactants, zwitterionic surfactants, or combinations thereof. In certain embodiments, the emulsifier can include sulfate, sulfonates, ethoxylated alcohols, ethoxylated triglycerides, alkyl polyglycosides, amine oxides, betaines, sultaines, or combinations thereof.

In various embodiments, the composition can include one or more emulsifiers in about 0.002 wt. % to about 65 wt. %. In certain embodiments, the composition includes from about 0.1 wt. % to about 35 wt. % of the one or more emulsifiers. In certain embodiments, the composition includes from about 0.5 wt. % to about 25 wt. % of the one or more emulsifiers. In further embodiments, the composition includes from about 1 wt. % to about 15 wt. % of the one or more emulsifiers. In particular embodiments, the composition includes from about 5 wt. % to about 15 wt. % of the one or more emulsifiers. In certain embodiments, the composition includes about 10 wt. % of the one or more emulsifiers.

While specific values chosen for this embodiment are recited, it is to be understood that, within the scope of the disclosure, the concentration of emulsifier may vary to suit different applications. The concentration ranges of emulsifier will vary based on the additional components of the pest control composition, such as the active components and the carrier.

Solvent. The formulation or composition of the present disclosure may also include a solvent, for example to dissolve certain components, to enhance functionality of the components, or for textural and sensorial attributes. In some embodiments, the composition may include a mixture of two or more solvents. In some embodiments, the solvent includes isopropyl alcohol. In some embodiments, the solvent includes ethanol. In some embodiments, the solvent includes water. In certain embodiments, the solvent includes ethanol, isopropyl alcohol, water, acetyl tributyl citrate, triethyl citrate, isopropyl myristate, ethyl lactate, butyl lactate, 1,2-propylene carbonate, mineral oil, or combinations thereof.

The composition can include about 0.5 wt. % solvent to about 20 wt. % solvent. In some embodiments, the composition can include about 0.5 wt. %, about 3 wt. %, about 5 wt. %, about 7.5 wt %, about 10 wt. %, about 12 wt. %, about 15 wt. %, or about 20 wt. % solvent, based on the total weight of the composition. The composition can include the solvent from about 0.5 wt. % to about 10 wt. % solvent, based on the total weight of the composition. In particular embodiments, the composition includes about 7.5 wt. %, based on the total weight of the composition. While specific values chosen for this embodiment are recited, it is to be understood that, within the scope of the disclosure, the concentration of solvent may vary to suit different applications. The concentration ranges of solvent will vary based on the additional components of the pest control composition, such as the active components and the carrier.

pH modifier. According to embodiments of the present disclosure, the composition may also include a pH modifier. The pH of the composition is important to maintain the integrity and efficacy of the active ingredients during storage. The stability of the pH may also be important for the stability of the composition. The pH modifier can include pH adjusters and/or buffering agents. In some embodiments, the pH modifier can be citric acid, anhydrous citric acid, monosodium dihydrogen citrate, disodium hydrogen citrate, trisodium citrate, anhydrous trisodium citrate, trisodium citrate, monopotassium dihydrogen citrate, dipotassium hydrogen citrate, tripotassium citrate, or any hydrate thereof. In other embodiments, the pH modifier is monosodium phosphate monohydrate and disodium phosphate heptahydrate. In further embodiments, the pH modifier can be calcium acetate, calcium sulfate, potassium citrate, potassium acetate, potassium bicarbonate, potassium chloride, sodium acetate, calcium citrate, or combinations thereof.

In some embodiments, the composition can be maintained between a pH of about 5 to about 11, or between a pH of about 5 to about 9, or between about a pH of about 5 to about 8, or between a pH of about 5 to about 7. In certain embodiments, the composition can be maintained between a pH of about 5.5 to about 6.5. In other embodiments, the composition can be maintained between a pH of about 7 to about 12. In further embodiments, the composition can be maintained between a pH of about 9 to about 12. In still further embodiments, the composition can be maintained between a pH of about 10.5 to about 11.5.

In some embodiments, the composition can include the pH modifier in about 0.001 wt. % to about 0.1 wt. %, based on the total weight of the composition. In other embodiments, the composition can include the pH modifier in about 0.01 wt. % to about 0.08 wt. %, based on the total weight of the composition. In further embodiments, the composition can include the pH modifier in about 0.02 wt. % to about 0.06 wt. %, based on the total weight of the composition. In further embodiments, the composition can include the pH modifier in about 0.05 wt. %, based on the total weight of the composition. In even further embodiments, however, the composition is substantially free of a pH modifier. While specific values chosen for this embodiment are recited, it is to be understood that, within the scope of the disclosure, the concentration of pH modifier may vary to suit different applications. The concentration ranges of pH modifier will vary based on the additional components of the pest control composition, such as the active components and the carrier.

Preservative. According to embodiments of the present disclosure, the composition may also include a preservative, for example, to lengthen the shelf-life of the product composition or to eliminate microbial contamination risks in the composition. In some embodiments, the composition includes one or more preservatives. The preservative can be citric acid, potassium sorbate, sodium benzoate, and combinations thereof, in various embodiments.

In some embodiments, the composition can include the preservative in about 0.0001 wt. % to about 1 wt. %, based on the total weight of the composition. In certain embodiments, the composition can include the preservative in about 0.001 wt. % to about 1 wt. %, based on the total weight of the composition. In particular embodiments, the composition can include the preservative in about 0.01 wt. % to about 0.5 wt. %, based on the total weight of the composition. In still further embodiments, the composition can include the preservative in about 0.1 wt. % to about 0.4 wt. %, based on the total weight of the composition. In still further embodiments, the composition can include the preservative in about 0.3 wt. %, based on the total weight of the composition. In even further embodiments, however, the composition is substantially free of a preservative. While specific values chosen for this embodiment are recited, it is to be understood that, within the scope of the disclosure, the concentration of preservative may vary to suit different applications. The concentration ranges of the preservative will vary based on the additional components of the pest control composition, such as the active components and the carrier.

Carrier. The term “carrier” as used herein means a substance, which can be inorganic or organic and of synthetic or natural origin, with which the active compound is mixed or formulated to facilitate its application to the host, area, or other object to be treated, or to facilitate its storage, transport and/or handling. In certain embodiments, the carrier includes water, and in particular embodiments, the carrier is water. In some embodiments, the composition includes about 1 wt. % to about 95 wt. % carrier, based on the total weight of the composition. In some embodiments, the composition includes about 25 wt. % to about 95 wt. % carrier, based on the total weight of the composition. In certain embodiments, the composition includes about 40 wt. % to about 95 wt. % of carrier, based on the total weight of the composition. In other embodiments, the composition includes about 50 wt. % to about 95 wt. % carrier, based on the total weight of the composition. In some embodiments, the carrier includes salt water (e.g., water containing sodium chloride), where the salt can be present in about 0.5 wt. %, 1 wt. %, 5 wt. % or 10 wt. %. While specific values chosen for this embodiment are recited, it is to be understood that, within the scope of the disclosure, the amount of carrier may vary to suit different applications. The amount ranges of carrier will vary based on the additional components of the composition, such as the active components.

Propellant. According to embodiments of the present disclosure, the composition may also include a propellant, for example to provide a force to expel the formulation from the container. Here, the composition of the present disclosure may be combined with a suitable propellant to form an aerosol formulation. However, in other embodiments, the composition does not include a propellant and may be dispensed from a container manually, such as from a trigger-actuated container or bag container. In certain embodiments, the propellant can include a compressed gas. In other embodiments, the propellant can include methane, ethane, liquified petroleum gas (LPG), propane, pentane, isobutene, n-butane, isobutane, dimethyl ether, hydrofluorocarbons, 1,1-difluoroethane, 1,1,1,2-tetrafluoroethane, carbon dioxide, nitrogen, air, and any combinations thereof. In some embodiments, the propellant includes one of nitrogen, compressed air, and carbon dioxide. In still further embodiments, the propellant includes nitrogen. The propellant may be present in the compositions of this disclosure in an amount of from about 1 wt. % to about 50 wt. %, from about 5 wt. % to about 40 wt. %, from about 10 wt. % to about 30 wt. %, or from about 15 wt. % to about 25 wt. %, based on the total weight of the composition. While specific values chosen for this embodiment are recited, it is to be understood that, within the scope of the disclosure, the concentration of propellant may vary to suit different applications. The concentration ranges of propellant will vary based on the additional components of the insecticidal composition, including, but not limited to, the active components.

### EXAMPLES

The following Examples are provided to demonstrate and further illustrate certain embodiments and aspects of the present disclosure and are not to be construed as limiting the scope of the disclosure.

### Test Protocols

### Corrosion Risk

Corrosion risk of a metallic material under certain conditions can be evaluated or assessed based on the general or overall corrosion rate, pitting potential, and/or repassivation potential. These three aspects may be used to assess the impacts of formula additives including corrosion inhibitors on corrosion and pitting susceptibility.

Corrosion rate is defined as the rate at which a metal deteriorates or dissolves in a specific environment. The corrosion rate can be expressed as a loss of weight or a change in thickness. Typically, corrosion rates are reported in mpy (mils per year) or mmpy (millimeters per year) and are generally based on the number of mils (thousandths of an inch) or millimeters the formulation or composition penetrates the material each year. Therefore, to calculate the rate of corrosion over time using immersion testing, the following may be measured: (a) weight loss (i.e., the decrease in weight of a material (e.g., steel) during a reference time period); (b) density (i.e., the density of a material (e.g., steel)); (c) area of corrosion (i.e., total initial exposed surface area of a metal piece); and (d) exposure time period or duration of exposure. According to a first method using immersion testing, the corrosion rate is determined by measuring a weight of a component (e.g., an aerosol valve assembly) prior to submersion of the component within a formulation or composition, measuring the weight of the component after submersion and after a duration of time (e.g., one week, two weeks, three weeks, four weeks, etc.), comparing the initial weight of the component with the weight of the component after the exposure, and calculating thickness loss based on exposed area and material density. In some instances, corrosion rate may be determined based on direct thickness change measurements following exposure of the metal to the environment for a duration of time.

Corrosion rate may also be measured using electrochemical methods such as direct current polarization or cyclic polarization involving a test cell containing a metal test sample, a counter electrode, and a reference electrode, all exposed to the same test environment. These methods involve measurement of the corrosion potential (E_{corr}) in volts, and corrosion current (I_{corr}) in amperes per square centimeter (A/cm²), and the corrosion rate is calculated based on I_{corr}, the equivalent weight (EW) of the main corrosion reaction in grams, and the density (d) of the metal in grams per cubic centimeter (g/cm³). For example, Formula 1 provided below outlines a formula that may be used to calculate corrosion rate (CR) based on the corrosion current (I_{corr}), the equivalent weight (EW) of the main corrosion reaction in grams, and the density (d) of the metal in grams per cubic centimeter (g/cm³).

$$C R = 128 , 700 \times \frac{Icorr \times EW}{d} \qquad ( Formula 1 )$$

Pitting potential may also be used to observe and assess corrosion, thereby allowing for evaluation of corrosion inhibitors. Pitting potential (Eₚᵢₜ) is the least positive voltage at which pits develop or grow on a metallic surface. This is the electrochemical potential in a given environment above which a corrosion pit initiates on a metallic surface. Eₚᵢₜ is the potential at which the metal salt in solution is in equilibrium with the metal oxide. At potentials above Eₚᵢₜ, pits form and propagate on the metallic surface over time.

Repassivation potential is yet another measurement that can be observed and used to assess corrosion risk. Here, repassivation potential (E_{RP} or E_{f}) is the potential at which actively corroding pits are repassivated. In particular, repassivation potential may be determined by a polarization curve in the reverse direction, where after reaching an upper current limit, the potential sweep is reversed and changes direction from positive to negative, which sometimes makes the current diminish. Further, when the current crosses the previously measured low passive current, the repassivation potential may be determined.

### Example 1

Several formulations were prepared to determine and assess the effectiveness of numerous corrosion inhibitors. In particular, four formulations were prepared using the procedures and weight percentages discussed below. Then, steel valve assemblies were fully submerged in the formulations and kept at room temperature. The condition of each valve was observed by the naked eye at several points of time, including at the beginning (i.e., before submersion) to determine a baseline, two weeks after submersion, four weeks after submersion, and eight weeks after submersion. The formulations and the procedure for making the same are outlined first below, and then the results of the submersion observations are discussed thereafter.

Example Composition 1 was prepared and had the weight percentages outlined below in Table 1. In particular, the procedure for creating Example Composition 1 included the following steps: (i) adding water; (ii) stirring at 250 rotations per minute; (iii) adding glycerin and isopropyl alcohol; (iv) adding sodium lauryl sulfate; (v) adding sodium benzoate and citric acid; (v) adding essential oil(s); and (vi) stirring for an additional five minutes or until homogonous or fully dissolved.

Additionally, Example Composition 1 had a pH of about 5.36, a rosemary scent, and was a colorless solution.

TABLE 1
Example Composition 1

| Description | Function | Wt. % |
|---|---|---|
| PURIFIED WATER | Water / Carrier | 63.29 |
| GLYCERINE, USP, 99.5P | Emulsifier | 10.00 |
| Isopropyl Alcohol | Solvent | 7.50 |
| Sodium Lauryl Sulfate (28% | Active ingredient | 17.86 |
| solution) | | |
| Rosemary Oil | Active ingredient | 1.00 |
| Sodium Benzoate | Preservative | 0.30 |
| Citric Acid, Anhydrous | Antioxidant | 0.05 |

Example Composition 2 was prepared and had the weight percentages outlined below in Table 2. In particular, the procedure for creating Example Composition 2 included the following steps: (i) adding water; (ii) stirring at 250 rotations per minute; (iii) adding glycerin and isopropyl alcohol; (iv) adding sodium lauryl sulfate; (v) adding sodium benzoate; (vi) adding citric acid and ascorbic acid; (vii) adding essential oil(s); and (vi) stirring for an additional five minutes or until homogonous or fully dissolved.

Additionally, Example Composition 2 had a pH of about 4.21, a rosemary scent, and was a colorless solution.

TABLE 2
Example Composition 2

| Description | Function | Wt. % |
|---|---|---|
| PURIFIED WATER | Water / Carrier | 63.19 |
| GLYCERINE, USP, 99.5P | Emulsifier | 10.00 |
| Isopropyl Alcohol | Solvent | 7.50 |
| Sodium Lauryl Sulfate (28% | Active ingredient | 17.86 |
| solution) | | |
| Rosemary Oil | Active ingredient | 1.00 |
| Sodium Benzoate | Preservative | 0.30 |
| Vitamin C (Ascorbic Acid) | Antioxidant | 0.10 |
| Citric Acid, Anhydrous | Buffer | 0.05 |

Example Composition 3 was prepared and had the weight percentages outlined below in Table 3. In particular, the procedure for creating Example Composition 3 included the following steps: (i) adding water; (ii) stirring at 250 rotations per minute; (iii) adding glycerin; (iv) adding isopropyl alcohol; (v) adding sodium lauryl sulfate; (vi) adding salt; (vii) adding sodium benzoate; (viii) adding citric acid; (ix) adding Vitamin E; (x) adding rosemary oil and stirring for an additional five minutes or until homogonous or fully dissolved.

Additionally, Example Composition 3 had a pH of about 5.39, a rosemary scent, and was a colorless solution.

TABLE 3
Example Composition 3

| Description | Function | Wt. % |
|---|---|---|
| Purified Water | Water / Carrier | 62.19 |
| Glycerin, USP, 99.5P | Emulsifier | 10.00 |
| Isopropyl Alcohol | Solvent | 7.50 |
| Sodium Lauryl Sulfate (28% | Active ingredient | 17.86 |
| solution) | | |
| Sodium Chloride | Salt | 1.00 |
| Sodium Benzoate | Preservative | 0.30 |
| Citric Acid, Anhydrous | Buffer | 0.05 |
| Vitamin E | Antioxidant | 0.10 |
| Rosemary oil | Active ingredient | 1.00 |

Example Composition 4 was prepared and had the weight percentages outlined below in Table 4. In particular, the procedure for creating Example Composition 4 included the following steps: (i) adding water; (ii) stirring at 250 rotations per minute; (iii) adding sodium nitrite; (iv) adding glycerin and isopropyl alcohol; (v) adding sodium lauryl sulfate; (vi) adding essential oil(s); (vii) adding sodium benzoate and citric acid; (viii) stirring for an additional five minutes or until homogonous or fully dissolved.

Additionally, Example Composition 4 had a pH of about 5.17, a rosemary scent, and was a yellowing color.

TABLE 4
Example Composition 4

| Description | Function | Wt. % |
|---|---|---|
| Purified Water | Water / Carrier | 63.19 |
| Sodium Nitrite | Corrosion inhibitor | 0.10 |
| Glycerin, USP, 99.5P | Emulsifier | 10.00 |
| Isopropyl Alcohol | Solvent | 7.50 |
| Sodium Lauryl Sulfate (28% | Active Ingredient | 17.86 |
| Solution) | | |
| Rosemary Oil | Active Ingredient | 1.00 |
| Sodium Benzoate | Preservative | 0.30 |
| Citric Acid, Anhydrous | Buffer | 0.05 |

As previously mentioned, the aforementioned formulations were assessed to determine the effectiveness of the corrosion inhibitors therein. In particular, steel valve assemblies were fully submerged in the aforementioned formulations and were examined at several points of time, including at the beginning (i.e., before submersion) to determine a baseline, two weeks after submersion, four weeks after submersion, and eight weeks after submersion.

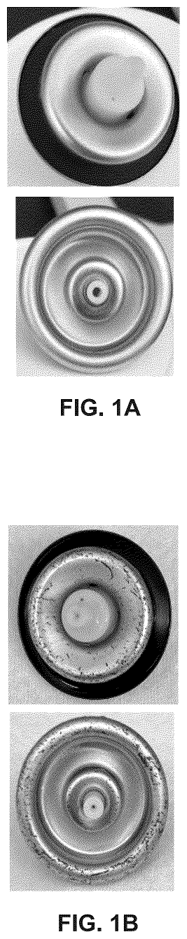

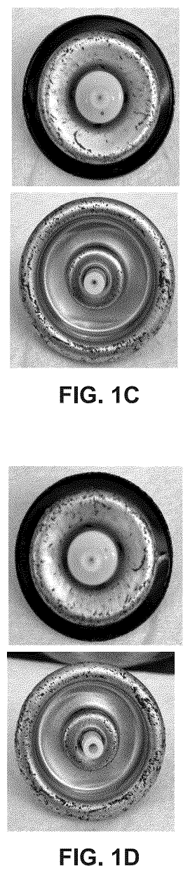

FIGS. 1A-D show top and bottom photographic images of the steel valve, and corrosion thereof, for Example Composition 1. More particularly, FIG. 1A shows top and bottom photographic images of the steel valve at the beginning of the testing—i.e., prior to submerging the valve assembly into Example Composition 1—and FIGS. 1B, 1C, and 1D show top and bottom photographic images of the steel valve after two, four, and eight weeks of submersion, respectively.

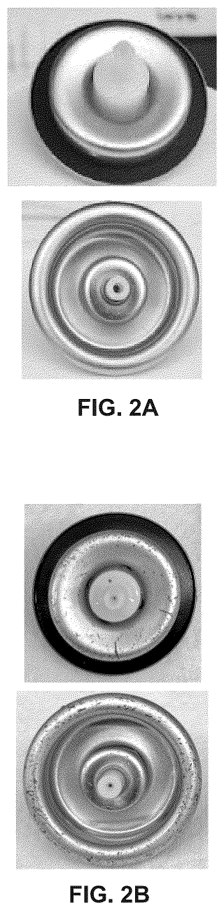

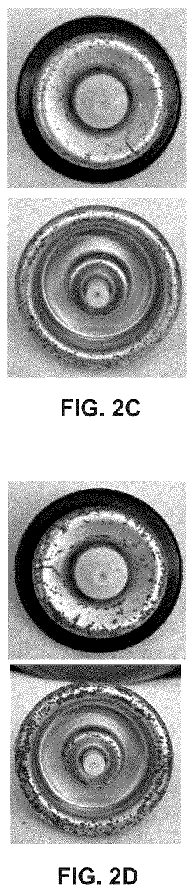

FIGS. 2A-D show top and bottom photographic images of the steel valve, and corrosion thereof, for Example Composition 2. More particularly, FIG. 2A shows top and bottom photographic images of the steel valve at the beginning of the testing—i.e., prior to submerging the valve assembly into Example Composition 2—and FIGS. 2B, 2C, and 2D show top and bottom photographic images of the steel valve after two, four, and eight weeks of submersion, respectively.

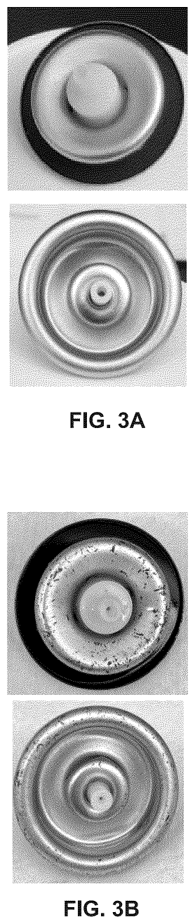

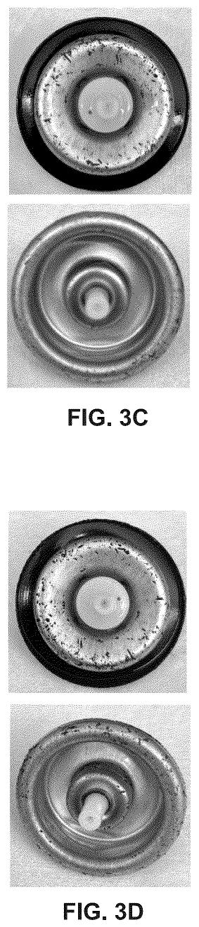

FIGS. 3A-D show top and bottom photographic images of the steel valve, and corrosion thereof, for Example Composition 3. More particularly, FIG. 3A shows top and bottom photographic images of the steel valve at the beginning of the testing—i.e., prior to submerging the valve assembly into Example Composition 3—and FIGS. 3B, 3C, and 3D show top and bottom photographic images of the steel valve after two, four, and eight weeks of submersion, respectively.

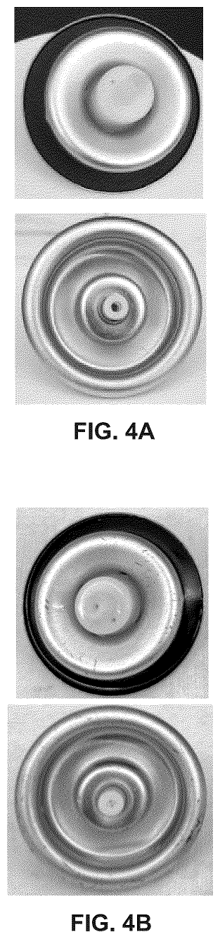

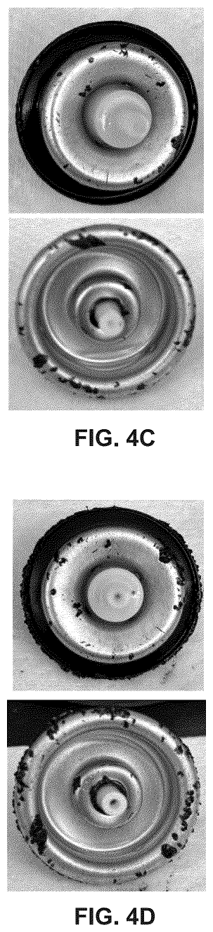

FIGS. 4A-D show top and bottom photographic images of the steel valve, and corrosion thereof, for Example Composition 4. More particularly, FIG. 4A shows top and bottom photographic images of the steel valve at the beginning of the testing—i.e., prior to submerging the valve assembly into Example Composition 4—and FIGS. 4B, 4C, and 4D show top and bottom photographic images of the steel valve after two, four, and eight weeks of submersion, respectively.

As shown by a comparison of FIGS. 1-4, the formulations or compositions having Vitamin C or Vitamin E exhibited approximate parity to improved results, when compared with formulations or compositions having alternative or corrosion inhibitors known in the art. For example, Example Compositions 1 and 4 do not include Vitamin C or Vitamin E, and either fail to include a corrosion inhibitor or a corrosion inhibitor known in the art, such as sodium nitrite. Further, when reference to FIGS. 1D, 2D, 3D, and 4D, Compositions 2 and 3 (which include Vitamin C or Vitamin E therein) exhibited either comparable or less corrosion, when compared to the corrosion observed with Compositions 1 and 4. Most notably, Composition 3 yielded unexpectantly superior results compared to Compositions 1 and 4, as can be observed throughout the figures.

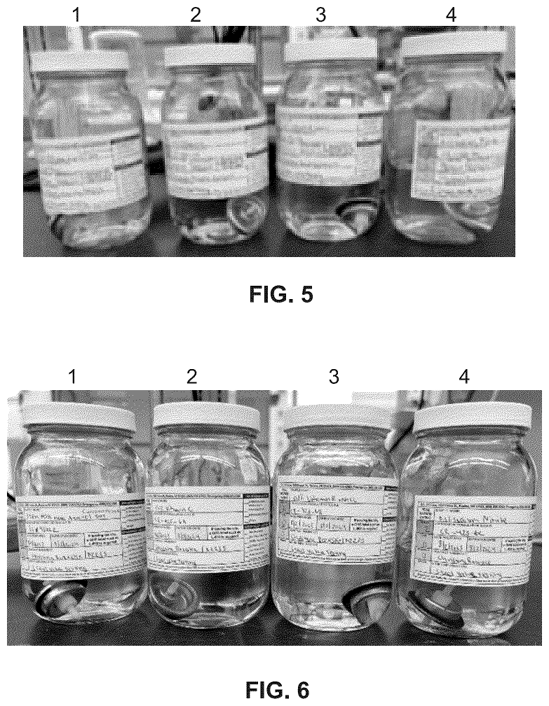

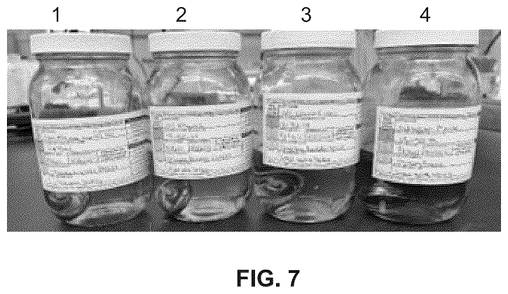

Additionally, FIGS. 5-7 show photographic images of the Example Compositions 1-4 after two weeks, four weeks, and eight weeks, respectively. As shown therein, all of the solutions turned yellow or green over time. Composition 4 was the worst of the formulations, as Composition 4 observed the most color change throughout two weeks, while Compositions 2 and 3 (which included Vitamin C and Vitamin E, respectively) unexpectedly showed the smallest change in color.

### Example 2

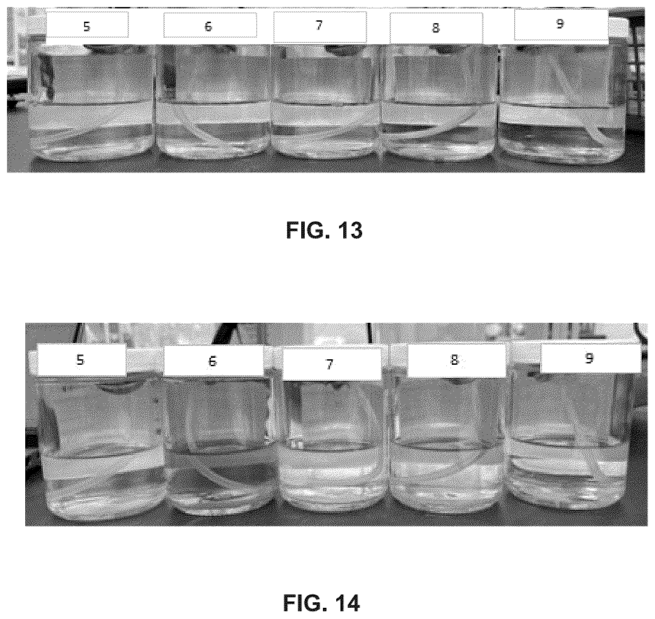

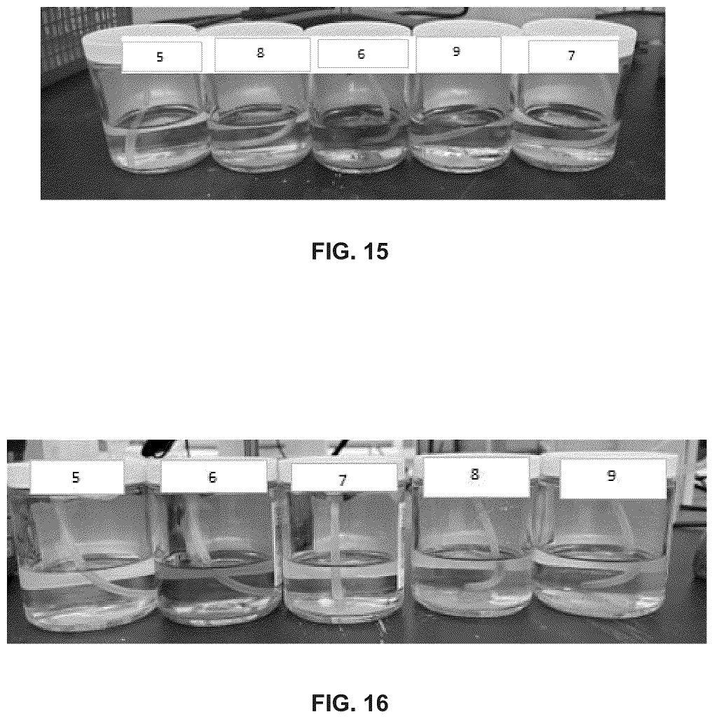

Several formulations were also prepared to determine and assess the effectiveness of corrosion inhibitors when positioned above a formulation (i.e., not submerged, but positioned in a headspace above the formulation). Here, five formulations were prepared using the procedures and weight percentages discussed below. Then, steel valve assemblies were positioned in a headspace above the formulations, as shown in FIGS. 13-16, and were examined by the naked eye at several points of time, including at the beginning (i.e., before exposing the steel valve assemblies to the formulations) to determine a baseline, one week after exposure to the formulations, two weeks after exposure to the formulations, and three weeks after exposure to the formulations. The formulations and the procedure for making the same are outlined first below, and then the results of the corrosion observations are discussed thereafter.

Example Composition 5 was prepared and had the weight percentages outlined below in Table 5. In particular, the procedure for creating Example Composition 5 included the following steps: (i) adding water; (ii) stirring at 300 rotations per minute, then 250 rotations per minute; (iii) adding glycerin and isopropyl alcohol; (iv) adding sodium lauryl sulfate; (v) adding sodium benzoate and citric acid; (vi) adding essential oil(s); and (vii) stirring for an additional five minutes or until homogonous or fully dissolved.

Additionally, Example Composition 5 had a pH of about 5.96, a rosemary scent, and was a colorless solution.

TABLE 5
Example Composition 5

| Description | Function | Wt. % |
|---|---|---|
| PURIFIED WATER | Water / Carrier | 63.29 |
| GLYCERINE, USP, 99.5P | Emulsifier | 10.00 |
| Isopropyl Alcohol | Solvent | 7.50 |
| Sodium Lauryl Sulfate (28% | Active ingredient | 17.86 |
| solution) | | |
| Rosemary Oil | Active ingredient | 1.00 |
| Sodium Benzoate | Preservative | 0.30 |
| Citric Acid, Anydrous | Antioxidant | 0.05 |

Example Composition 6 was prepared and had the weight percentages outlined below in Table 6. In particular, the procedure for creating Example Composition 6 included the following steps: (i) adding water; (ii) stirring at 300 rotations per minute, and then 250 rotations per minute; (iii) adding glycerin and isopropyl alcohol; (iv) adding sodium lauryl sulfate; (v) adding sodium benzoate; (vi) adding ascorbic acid; (vii) adding essential oil(s); and (viii) stirring for an additional five minutes or until homogonous or fully dissolved.

Additionally, Example Composition 6 had a pH of about 5.96, a rosemary scent, and was a colorless solution.

TABLE 6
Example Composition 6

| Description | Function | Wt. % |
|---|---|---|
| PURIFIED WATER | Water / Carrier | 63.24 |
| GLYCERINE, USP, 99.5P | Emulsifier | 10.00 |
| Isopropyl Alcohol | Solvent | 7.50 |
| Sodium Lauryl Sulfate (28% | Active ingredient | 17.86 |
| Solution) | | |
| Rosemary Oil | Active ingredient | 1.00 |
| Sodium Benzoate | Preservative | 0.30 |
| Vitamin C (Ascorbic Acid) | Antioxidant | 0.10 |

Example Composition 7 was prepared and had the weight percentages outlined below in Table 7. In particular, the procedure for creating Example Composition 7 included the following steps: (i) adding water; (ii) stirring at 300 rotations per minute; (iii) adding glycerin; (iv) adding isopropyl alcohol; (v) adding sodium lauryl sulfate; (vi) adding salt; (vii) adding sodium benzoate; (viii) adding citric acid; (ix) adding Vitamin E; and (x) adding rosemary oil and stirring for an additional five minutes or until homogonous or fully dissolved.

Additionally, Example Composition 7 had a pH of about 5.81, a rosemary scent, and was a hazy solution after batching, but a clear solution after sitting overnight.

TABLE 7
Example Composition 7

| Description | Function | Wt. % |
|---|---|---|
| Purified Water | Water / Carrier | 62.19 |
| Glycerin, USP, 99.5P | Emulsifier | 10.00 |
| Isopropyl Alcohol | Solvent | 7.50 |
| Sodium Lauryl Sulfate (28% | Active ingredient | 17.86 |
| solution) | | |
| Sodium Chloride | Salt | 1.00 |
| Sodium Benzoate | Preservative | 0.30 |
| Citric Acid, Anhydrous | Buffer | 0.05 |
| Vitamin E | Antioxidant | 0.10 |
| Rosemary oil | Active ingredient | 1.00 |

Example Composition 8 was prepared and had the weight percentages outlined below in Table 8. In particular, the procedure for creating Example Composition 8 included the following steps: (i) adding water; (ii) stirring at 300 rotations per minute; (iii) adding sodium nitrite; (iv) adding glycerin; (v) adding isopropyl alcohol; (vi) adding sodium lauryl sulfate; (vii) adding sodium benzoate and citric acid; (viii) adding essential oil(s); and (ix) stirring for an additional five minutes or until homogonous or fully dissolved.

Additionally, Example Composition 8 had a pH of about 6.09, a rosemary scent, and was a clear colorless solution.

TABLE 8
Example Composition 8

| Description | Function | Wt. % |
|---|---|---|
| Purified Water | Water / Carrier | 63.19 |
| Sodium Nitrite | Corrosion inhibitor | 0.10 |
| Glycerin, USP, 99.5P | Emulsifier | 10.00 |
| Isopropyl Alcohol | Solvent | 7.50 |
| Sodium Lauryl Sulfate (28% | Active Ingredient | 17.86 |
| Solution) | | |
| Rosemary Oil | Active Ingredient | 1.00 |
| Sodium Benzoate | Preservative | 0.30 |
| Citric Acid, Anhydrous | Buffer | 0.05 |

Example Composition 9 was prepared and had the weight percentages outlined below in Table 9. In particular, the procedure for creating Example Composition 9 included the following steps: (i) adding water; (ii) stirring at 300 rotations per minute; (iii) adding glycerin; (iv) adding isopropyl alcohol; (v) adding sodium lauryl sulfate; (vi) adding salt; (vii) adding sodium benzoate; (viii) adding Vitamin E; (ix) adding rosemary oil and stirring for an additional five minutes or until homogonous or fully dissolved.

Additionally, Example Composition 9 had a pH of about 11.52, a rosemary scent, and was hazy after batching but clear after sitting overnight.

TABLE 9
Example Composition 9

| Description | Function | Wt. % |
|---|---|---|
| Purified Water | Water / Carrier | 62.24 |
| Glycerin, USP, 99.5 | Emulsifier | 10.00 |
| Isopropyl Alcohol | Solvent | 7.50 |
| Sodium Lauryl Sulfate (28% | Active Ingredient | 17.86 |
| Solution) | | |
| Sodium Chloride | Salt | 1.00 |
| Sodium Benzoate | Preservative | 0.30 |
| Vitamin E | Antioxidant | 0.10 |
| Rosemary oil | Active ingredient | 1.00 |

As previously mentioned, the aforementioned formulations were assessed to determine the effectiveness of the corrosion inhibitors therein. In particular, steel valve assemblies were positioned in a headspace above one of the aforementioned formulations and were examined at several points of time, including at the beginning (i.e., before exposure) to determine a baseline, one week after exposure, two weeks after exposure, and three weeks after exposure.

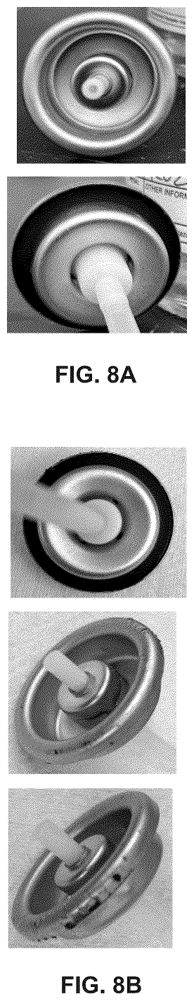

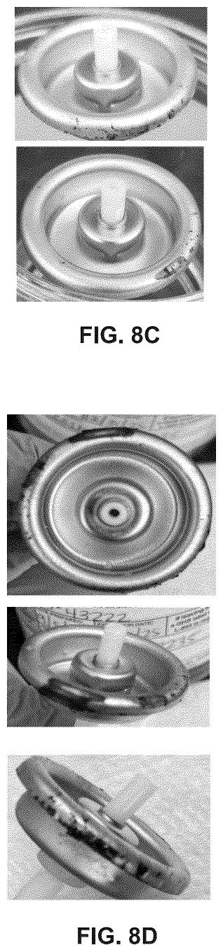

FIGS. 8A-D show photographic images of a steel valve assembly, and corrosion thereof, for Example Composition 5. More particularly, FIG. 8A shows photographic images of the steel valve at the beginning of the testing—i.e., prior to exposing the valve assembly to Example Composition 5—and FIGS. 8B, 8C, and 8D show photographic images of the steel valve assembly after one, two, and three weeks of exposure, respectively.

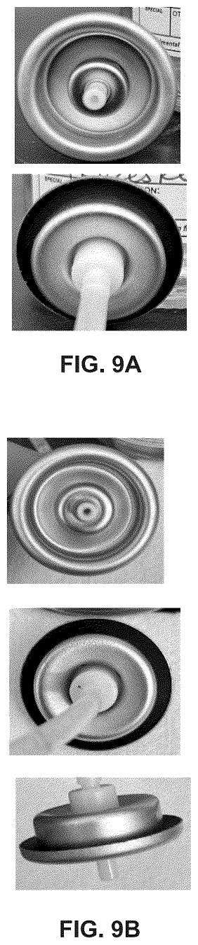

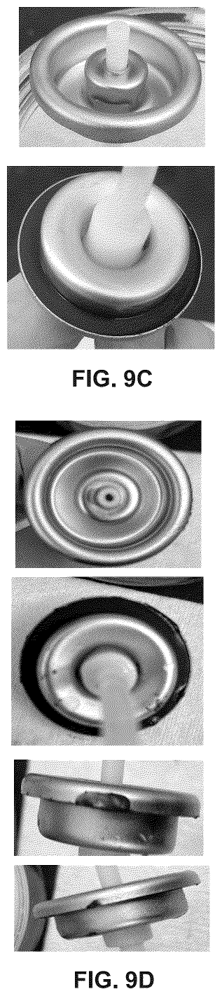

FIGS. 9A-D show photographic images of a steel valve assembly, and corrosion thereof, for Example Composition 6. More particularly, FIG. 9A shows photographic images of the steel valve at the beginning of the testing—i.e., prior to exposing the valve assembly to Example Composition 6—and FIGS. 9B, 9C, and 9D show photographic images of the steel valve assembly after one, two, and three weeks of exposure, respectively.

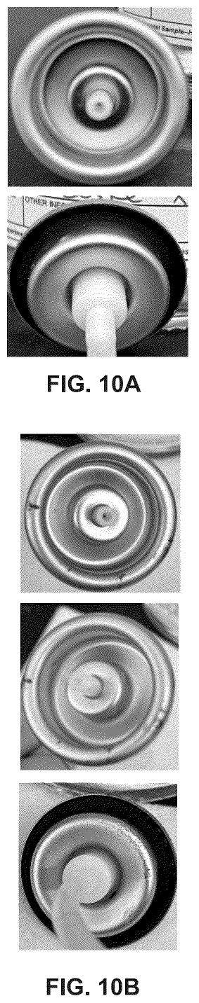

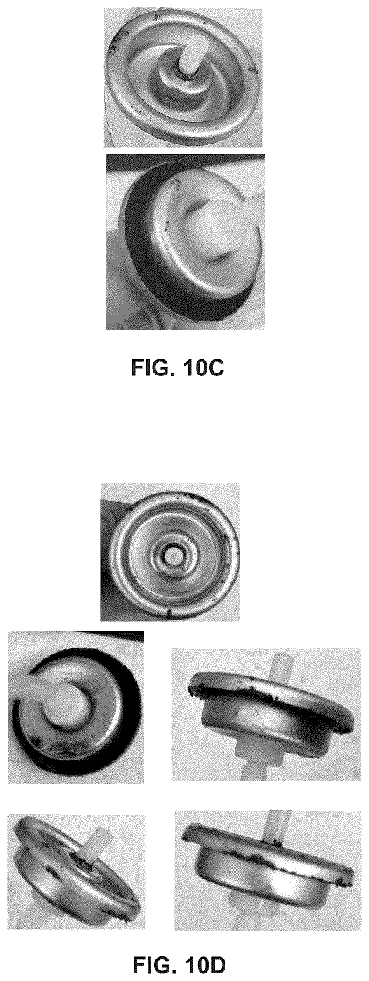

FIGS. 10A-D show photographic images of a steel valve assembly, and corrosion thereof, for Example Composition 7. More particularly, FIG. 10A shows photographic images of the steel valve at the beginning of the testing—i.e., prior to exposing the valve assembly to Example Composition 7—and FIGS. 10B, 10C, and 10D show photographic images of the steel valve assembly after one, two, and three weeks of exposure, respectively.

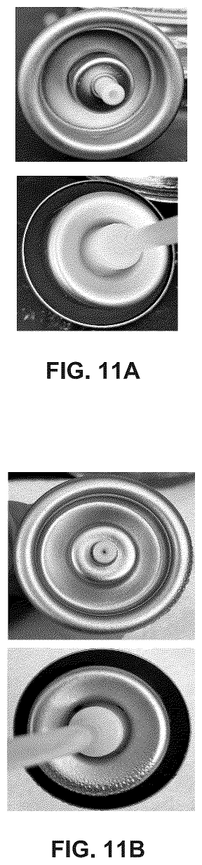

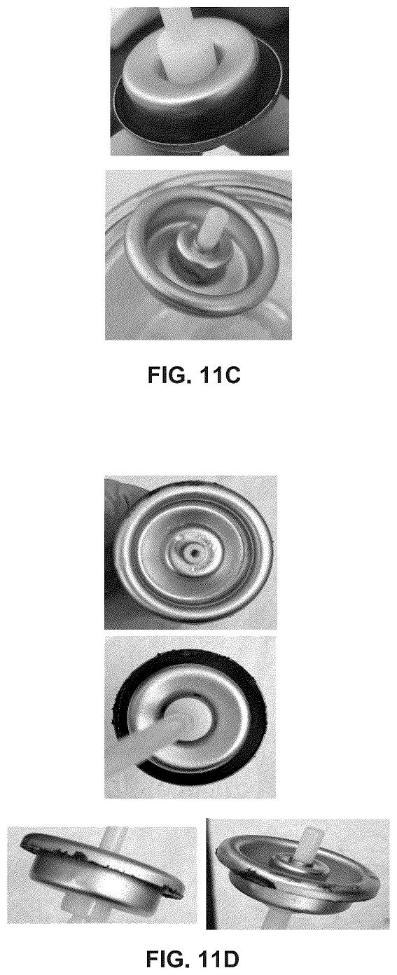

FIGS. 11A-D show photographic images of a steel valve assembly, and corrosion thereof, for Example Composition 8. More particularly, FIG. 10A shows photographic images of the steel valve at the beginning of the testing—i.e., prior to exposing the valve assembly to Example Composition 8—and FIGS. 11B, 11C, and 11D show photographic images of the steel valve assembly after one, two, and three weeks of exposure, respectively.

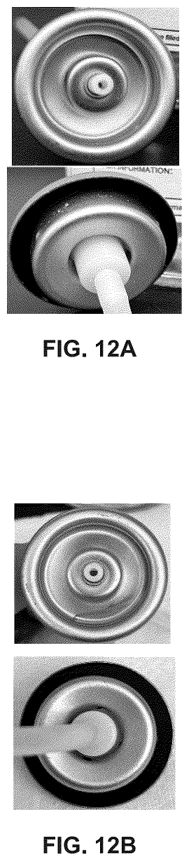

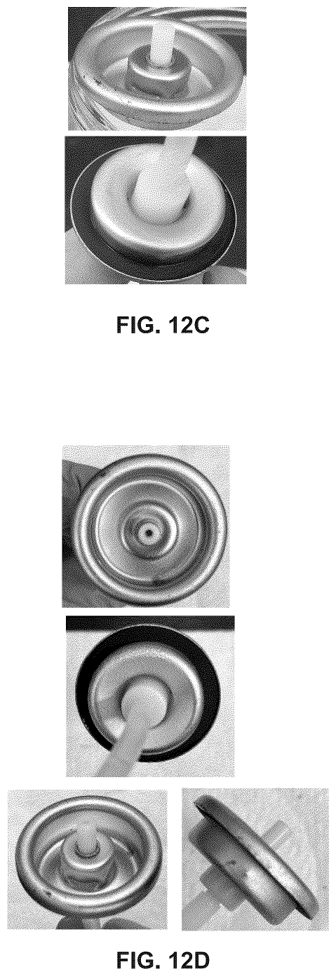

FIGS. 12A-D show photographic images of a steel valve assembly, and corrosion thereof, for Example Composition 9. More particularly, FIG. 12A shows photographic images of the steel valve at the beginning of the testing—i.e., prior to exposing the valve assembly to Example Composition 9—and FIGS. 12B, 12C, and 12D show photographic images of the steel valve assembly after one, two, and three weeks of exposure, respectively.

As shown by a comparison of FIGS. 8-12, the formulations or compositions having Vitamin C or Vitamin E exhibited comparable to improved results, when compared with formulations or compositions having alternative or corrosion inhibitors known in the art. For example, Example Compositions 5 and 8 do not include Vitamin C or Vitamin E, and either fail to include a corrosion inhibitor or include a corrosion inhibitor known in the art, such as sodium nitrite. Further, with reference to FIGS. 8D, 9D, 10D, 11D, and 12D, Compositions 6, 7, and 9 (which include Vitamin C or Vitamin E therein) exhibited either comparable or less corrosion, when compared to the corrosion observed with Compositions 5 and 8.

In particular, visible rust was observed for Composition 5 after one week, two weeks, and three weeks. No corrosion or slight corrosion was observed for Composition 6 after one or two weeks. After three weeks, some visible rust was observed for Composition 6. Additionally, some rust was observed for Composition 7 after one, two, and three weeks; however, the rust was comparable to the corrosion observed for Composition 5. Even further, it was surprising and unexpected that no corrosion was observed for Composition 9 after one week. No corrosion, but some slight rust was observed for Composition 9 after two weeks; however, the rust was minimal. Last, there was some visible rust for Composition 9 after three weeks.

Composition 8 included sodium nitrite. Here, no corrosion (but maybe some slight minor de-tinning) was observed after one week. Additionally, some slight rust was observed for Composition 8 after two and three weeks.

Additionally, FIGS. 13-16 show photographic images of the Example Compositions 5-9 at the beginning of testing, and after one, two, and three weeks, respectively. As shown in FIGS. 13-16, Example Composition 8 was slightly yellow at the beginning of testing. Further, color change was observed for Example Composition 6 and Example Composition 8 after one week.

It should be understood that the decimal values in the aforementioned exemplary compositions can be rounded to a single decimal value or no decimal values. For instance, 9.2 can be considered 9, and 9.18 can be considered 9.2 or 9. It should also be understood that the values presented in Table 5 can be approximate and may vary by about 10-20% from the listed value.

The various methods and techniques described above provide a number of ways to carry out embodiments of the present disclosure. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the at least two active ingredients selected for the pest control composition, the target pest, and the amounts of the various ingredients present in the pest control composition. Various embodiments of the invention can specifically include or exclude any of these variations or elements.

In some embodiments, the numbers expressing quantities of ingredients, properties such as weight percentages, percent repellency, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the present disclosure (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Particular embodiments of the present disclosure are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

It is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention. The exclusive rights to all modifications which come within the scope of the appended claims are reserved.

We claim:

1. A composition comprising:
one or more active ingredients; and
a corrosion inhibitor, wherein the corrosion inhibitor is selected from the group consisting of Vitamin C, Vitamin E, and combinations thereof.

2. The composition of claim 1, wherein the corrosion inhibitor is Vitamin C, and the composition has a pH between about 5 and about 8.

3. The composition of claim 1, wherein the corrosion inhibitor is Vitamin E, and the composition has a pH between about 5 and about 8.

4. The composition of claim 1, wherein the corrosion inhibitor is Vitamin E, and the composition has a pH between about 9 and about 12.

5. The composition of claim 1, wherein the one or more active ingredients is selected from the group consisting of pyrethrins, rosemary oil, cornmint oil, peppermint oil, spearmint oil, rosemary oil, thyme oil, citronella oil, clove oil, cedarwood oil, sodium lauryl sulfate, and any combination thereof, and wherein the one or more active ingredients is about 0.001 wt. % to about 10 wt. %, based on the total weight of the composition.

6. The composition of claim 1, wherein the one or more active ingredients is selected from the group consisting of rosemary oil, sodium lauryl sulfate, and a combination thereof.

7. The composition of claim 1, wherein the one or more active ingredients are present in an amount of about 0.001 wt. % to about 10 wt. %, based on the total weight of the composition.

8. The composition of claim 1, wherein the composition further includes one or more emulsifier, and the one or more emulsifiers is selected from the group consisting of glycerin, potassium oleate, polysorbate 80, sorbitan monooleate, and any combination thereof.

9. The composition of claim 8, wherein the one or more emulsifiers are present in an amount of about 0.1 wt. % to about 35 wt. %, based on the total weight of the composition.

10. The composition of claim 1, further comprising a pH modifier, wherein the pH modifier is selected from the group consisting of citric acid, anhydrous citric acid, trisodium citrate, monosodium phosphate monohydrate, disodium phosphate heptahydrate, and combinations thereof.

11. The composition of claim 1, wherein the pH modifier is present from about 0.001 wt. % to about 0.1 wt. %, based on the total weight of the composition.

12. The composition of claim 1, wherein the corrosion inhibitor is present from about 0.05 wt. % to about 0.5 wt. %, based on the total weight of the composition.

13. The composition of claim 1, further comprising a propellant selected from the group consisting of nitrogen, compressed air, and carbon dioxide.

14. The composition of claim 1, further comprising a solvent selected from the group consisting of ethanol, isopropanol, and combinations thereof, and wherein the solvent is present from about 0.5 wt. % to about 20 wt. %, based on the total weight of the composition.

15. A pest repellent composition comprising:
an active ingredient; and
vitamin C,
wherein the pH of the composition is from about 5.5 to about 7.

16. The composition of claim 15, wherein the composition further includes an emulsifier.

17. The composition of claim 15, wherein the active ingredient is selected from the group consisting of sodium lauryl sulfate, rosemary oil, and any combination thereof.

18. A composition comprising:
an active ingredient; and
vitamin E,
wherein the pH of the composition is from about 7 to about 12.

19. The composition of claim 18, wherein the composition further includes an emulsifier.

20. The composition of claim 18, wherein the active ingredient is selected from the group consisting of sodium lauryl sulfate, rosemary oil, and any combination thereof.
